(19) United States
(12) Patent Application Publication
(10) Pub. No.: US 2009/0018955 A1
(43) Pub. Date: Jan. 15, 2009

(54) METHOD AND APPARATUS FOR PROVIDING USER ACCESS TO PAYMENT METHODS

(76) Inventors: Yen-Fu Chen, Austin, TX (US); Fabian F. Morgan, Austin, TX (US); Keith Raymond Walker, Austin, TX (US); Sarah Vijoya White Eagle, Austin, TX (US)

Correspondence Address: IBM CORP (YA);C/O YEE & ASSOCIATES PC, P.O. BOX 802333, DALLAS, TX, 75380, US

(21) Appl. No.: 11/777,647

(22) Filed: Jul. 13, 2007

(51) Int. Cl. G06Q 40/00

(52) U.S. Cl. 705/39; 705/26; 705/38

(57) ABSTRACT

The illustrative embodiments described herein provide a computer-implemented method, apparatus, and computer program product for providing user access to payment methods. The process generates a set of recommended payment methods in a set of payment methods to form a recommendation. The set of recommended payment methods are recommended to complete the transaction. The process provides the recommendation to a user on a user interface. The process provides the application for the user to apply for the right to use the recommended payment method on a user interface in response to a determination that a recommended payment method in the recommendation is presently unavailable to the user.

### BACKGROUND OF THE INVENTION

1. Field of the Invention

The present invention relates generally to a data processing system and in particular to a method and system for transactions. More particularly, the present invention is directed to a computer-implemented method, apparatus, and computer program product for providing an application for a right to utilize a payment method to be used to complete a transaction.

2. Description of the Related Art

An increasingly large number of payment methods have become available to consumers engaged in purchase transactions. A payment method is any method, medium, or service that may be used to effectuate payment in a transaction, such as credit cards, debit cards, gift cards, bank transfers, tokens, vouchers, store-specific credit cards, or any other forms of legal tender or exchange that may be used to complete a transaction. A payment method may also include utilizing a promotion in conjunction with a particular payment method. Consumers have the option of choosing between different types of payment methods when making a purchase. Various payment method providers, such as credit card companies, banks, and retailers, frequently provide consumers with multiple payment method options.

Competition between payment method providers has led to the introduction of incentive programs. Under these programs, payment method providers offer incentives and rewards, such as frequent flier miles, cash-back, and gift certificates, to entice consumers to use their respective payment methods to make a purchase.

Incentive programs differ with respect to the types of rewards offered. For example, credit cards allow consumers to earn points for purchases made using a particular credit card. The earned points may then be used by the consumer to purchase merchandise from a catalog, receive cash-back, obtain frequent flier miles, receive an annual bonus that is based on the amount of cash-back earned with the payment method, or receive gift cards or gift certificates that must be applied toward merchandise at a predetermined retailer. In addition, some credit cards round-up the purchase prices of items purchased using the credit card to the nearest dollar and apply the difference between the purchase price and the rounded price to a savings account owned by the consumer or a relative of the consumer. Additionally, some credit cards and debit cards also allow the consumer to choose the type of reward they would like to receive from a set of reward options.

Also, incentive programs often offer rewards that depend on the details of the particular purchase transaction. For example, some payment methods offer cash-back on purchases related to a particular category of business. Specifically, a credit card may offer cash-back or an increased percentage of cash-back for purchases related to travel, such as airline ticket purchases, bus ticket purchases, car rentals, and hotels. As another example, some credit cards offer cash-back or an increased percentage of cash-back for payments made on utility bills, such as cable and electric bills. Other credit cards increase the cash-back percentage earned by consumers when purchases are made using a particular credit card at a particular retailer or when a purchase is made during a particular time period.

Due to the large number of payment methods to choose from and the large variety of incentive programs associated with each payment method, consumers can lose track of the incentive programs for which they could be eligible. Because payment method providers often change or update their incentive programs, consumers may not even be aware of the rewards for which they are eligible.

A payment method offering a superior reward may not be owned or available to the consumer during a transaction because the consumer has failed to apply for access to the payment method, such as applying for a credit card. Further, if the customer does not already have access to the payment method, the consumer often has no means to obtain or apply for the payment method during the transaction.

Payment method providers may also provide rewards to consumers that have applied for a promotion associated with a payment method. However, because consumers often do not have the ability to apply for promotions during a transaction, consumers may miss the opportunity to earn rewards for a particular promotion associated with a payment method.

Also, rewards that are dependent upon a location or type of business at which the transaction takes place may fail to be rewarded to a consumer if the location or type of business is not recognized by the payment method provider. As a result, consumers often miss the opportunity to earn or maximize the rewards they can receive from the purchases they make.

In addition, the large-scale use of different payment method presents a massive of data. Payment method providers often have no way to extract useful data from this massive amount of payment method usage data, instead relying on inferior reasoning to create marketing campaigns, promotions, and incentive programs.

The problem faced by consumers is further compounded by the large amount of time that may be necessary for a consumer to become familiar with the details of the various incentive programs for which the consumer might be eligible. Moreover, due to the short duration of some purchase transactions, even consumers with knowledge of the incentive programs for which they are eligible may experience difficulty making a timely determination as to which payment method should be used to maximize their rewards.

### SUMMARY OF THE INVENTION

The illustrative embodiments described herein provide a computer-implemented method, apparatus, and computer program product for providing user access to payment methods. The process generates a set of recommended payment methods in a set of payment methods to form a recommendation. The set of recommended payment methods are recommended to complete the transaction. The process provides the recommendation to a user on a user interface. The process provides the application for the user to apply for the right to use the recommended payment method on a user interface in response to a determination that a recommended payment method in the recommendation is presently unavailable to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which the illustrative embodiments may be implemented;

FIG. 2 is a block diagram of a data processing system in which the illustrative embodiments may be implemented;

FIG. 3 is a block diagram of a data processing system for recommending a payment method in accordance with an illustrative embodiment;

FIG. 4 is a flowchart illustrating a process for providing an application for a right to use a recommended payment method in accordance with an illustrative embodiment;

FIG. 5 is a flowchart illustrating a process for verifying transaction data in accordance with an illustrative embodiment; and

FIG. 6 is a flowchart illustrating a process for providing payment method usage patterns in accordance with an illustrative embodiment.

### DETAILED DESCRIPTION OF THE PREFERRED EMBODIMENT

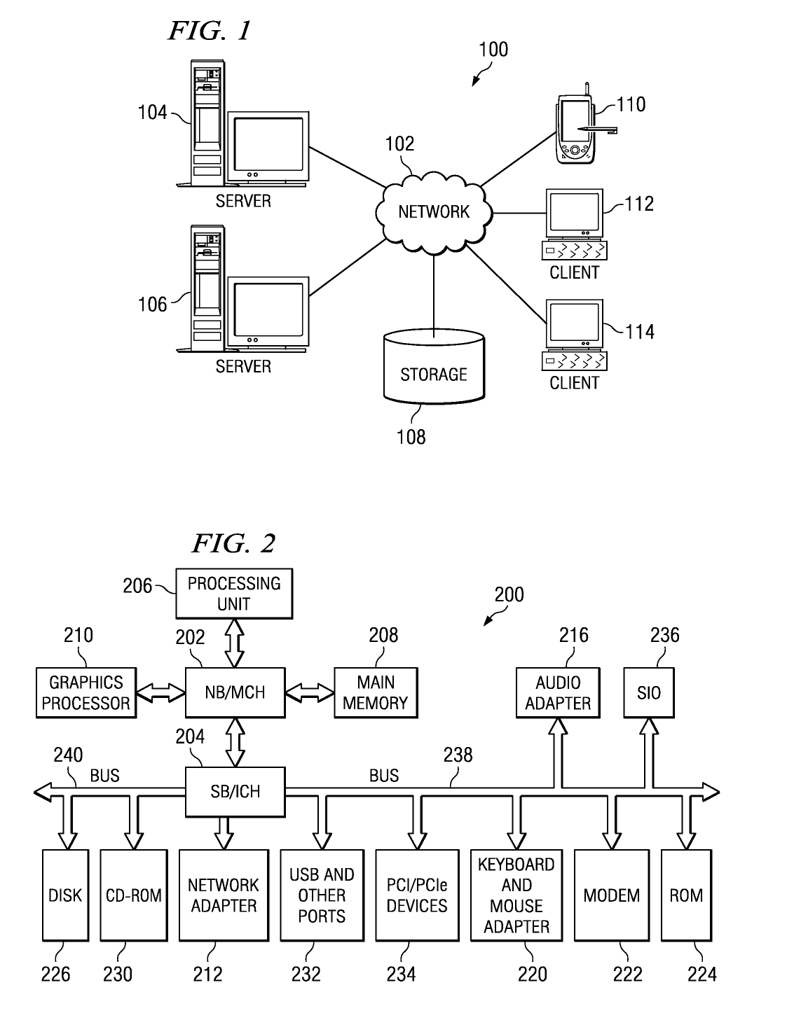

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Clients 110, 112, and 114 may be cash registers, gas pumps, cell phones, personal digital assistants, or any other interface at which a transaction may take place. In FIG. 1, client 110 is a personal digital assistant. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer-implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer-implemented method, apparatus, and computer program product for providing user access to payment methods. In one embodiment, the process generates a set of recommended payment methods in a set of payment methods to form a recommendation. The set of recommended payment methods are recommended to complete the transaction. The process provides the recommendation to a user on a user interface. The process provides the application for the user to apply for the right to use the recommended payment method on a user interface in response to a determination that a recommended payment method in the recommendation is presently unavailable to the user. A set of payment methods includes one or more payment methods. A transaction may be any transaction for which a payment method can be utilized, such as a purchase transaction, a monetary exchange, or any other transaction in which currency is transferred.

In an embodiment, the process assigns a rating to the user and provides the rating to a payment method provider. The rating is an indicator that is based on any of a variety of user attributes, such as repayment ability and the frequency with which the user uses a particular payment. In another example, the process receives data associated with the transaction to form transaction data and provides the transaction data to a payment method provider.

In another embodiment, the process identifies a set of patterns based on usage of the set of payment methods to form payment method usage patterns and providing the payment method usage patterns to a payment method provider. The set of patterns includes at least one pattern. A pattern characterizes data that is derived from usage of a set of payment methods by at least one user.

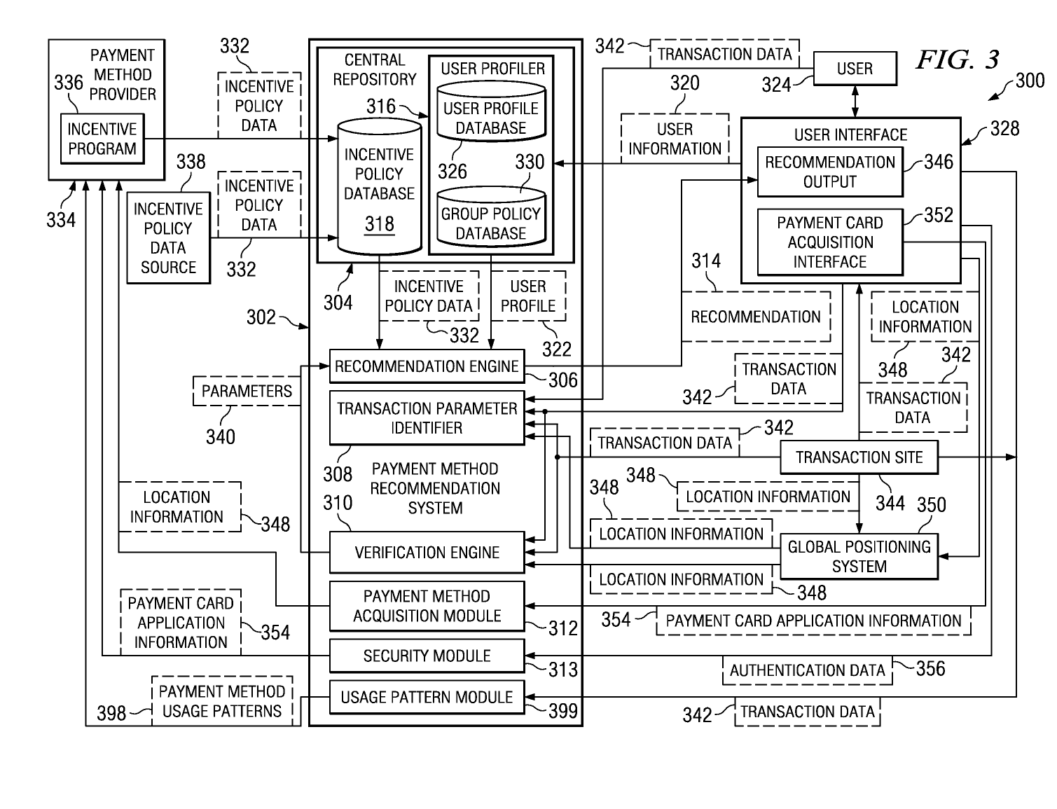

Turning now to FIG. 3, a block diagram is depicted of a data processing system for recommending a payment method in accordance with an illustrative embodiment. Data processing system 300 is a data processing system, such as network data processing system 100 of FIG. 1.

Payment method recommendation system 302 is software, hardware, or a combination thereof that recommends a payment method in a transaction.

In the illustrative embodiment of FIG. 3, payment method recommendation system 302 includes central repository 304, recommendation engine 306, transaction parameter identifier 308, verification engine 310, payment method acquisition module 312, security module 313 and usage pattern module 399. Each of these components of payment method recommendation system 302 will be addressed in turn.

Central repository 304 receives, generates, updates, and stores data that is used by recommendation engine 306 to generate recommendation 314. Central repository 304 includes user profiler 316 and incentive policy database 318.

User profiler 316 generates user profiles based on user information 320. User profile 322 contains characteristics about a user 324 that uses payment method recommendation system 302. For example, user profile 322 may contain information related to the identity of user 324, such as a name, address, phone number, e-mail address, and other biographical data for the user. Additionally, user profile 322 may contain information related to the types of payment methods owned, available, or used by user 324. For example, user profile 322 may indicate the number and type of credit cards, debit cards, gift cards, and store-specific credit cards owned or used by user 324. User profile 322 may also contain account information for each payment method owned or used by user 324.

User profiler 316 generates user profile 322 based on user information 320 received from user interface 328. User interface 328 may be any device that allows a user to send user information 320 to user profiler 316. For example, user interface 328 may be a data processing system, such as data processing systems 104, 106, 110, 112, and 114 in FIG. 1, a personal digital assistant such as client 110 in FIG. 1, a laptop computer, a cellular phone, a kiosk, an automatic teller machine (ATM), a user-interactive device at a retailer, a voice-recognition interface system, a touch screen, or any other interface that allows user 324 to send user information 320. User interface 328 may also work in conjunction with software interfaces, such as web browsers or any application associated with payment method recommendation system 302.

Additionally, user information 320 may be provided to user profiler 316 in conjunction with a registration process. The ability of user 324 to use payment method recommendation system 302 may be conditioned upon user 324 completing the registration process. During the registration process, security features may be set up that limit access to payment method recommendation system 302 based on a user's identity or registration status.

Although FIG. 3 depicts user information 320 as originating from user interface 328, user information 320 may originate from any source that contains user information. For example, an external storage device, such as storage unit 108 in FIG. 1, may send user information 320 to user profiler 316 to form user profile 322. Also, multiple user profiles may be formed by user information 320 that originates from an external storage device.

User profile 322 is stored on user profile database 326. Although FIG. 3 depicts only one user profile 322, user profile database 326 may contain any number of user profiles. For example, user profile database 326 may contain user profiles for each user 324 that uses or is registered to use payment method recommendation system 302. In addition, user profile database 326 may be located on a remote storage device accessible through a network, such as storage unit 108 of FIG. 1.

User profiler 316 also includes group policy database 330. Group policy database 330 contains information about the grouping of user profiles. User profiles may be grouped with one another to form grouped user profiles. Grouped user profiles allow users to combine their individual profiles to facilitate the earning of incentives. For example, the purchases made by the users in a grouped user profile may be combined to earn rewards for users included in the grouped user profile.

In addition to containing information about how user profiles are grouped together, the group policy database 330 also contains information about how rewards are distributed among the users in a grouped user profile. Although FIG. 3 depicts user profile database 326 and group policy database 330 as two separate databases, the information contained in user profile database 326 and group policy database 330 may also be contained in a single database.

Central repository 304 also includes incentive policy database 318. Incentive policy database 318 contains data regarding incentives that are available for using a set of payment methods. Incentives include any allurement that encourages a user to use a particular payment method, including, but not limited to, rewards, discounts, gift certificates, cash-back, frequent flier miles, and/or points.

The data regarding incentives and rewards forms incentive policy data 332, which is maintained by incentive policy database 318. Incentive policy database 318 may be included in a hard disk, such as hard disk drive 226 of FIG. 2, a local storage device, or a remote storage device accessible over a network, such as storage unit 108 of FIG. 1.

The set of payment methods includes one or more payment methods. The set of payment methods can include as many payment methods as necessary to reflect the number of payment methods available on the market. Alternatively, incentive policy database 318 may include incentive polices issued by vendors, such as hotels, airlines, and retailers.

Incentive policy data 332 is received by incentive policy database 318 from payment method provider 334. Payment method provider 334 may be any entity that provides payment methods for use in transactions, such as a credit card company, bank, or retailer. Incentive policy data 332 is derived from the incentive program 336 that is issued by payment method provider 334. In addition to initially receiving incentive policy data 332, incentive policy database 318 can maintain current incentive policy data 332 regarding incentive program 336 by receiving periodic updates of incentive policy data 332. Incentive policy data 332 may be received over a network, such as network 102 of FIG. 1.

Although FIG. 3 depicts payment method provider 334 as having one incentive program 336 from which incentive policy data 332 is derived, payment method provider 334 may include any number of incentive policies. For example, payment method provider 334 may have an incentive policy for each payment method that the payment method provider 334 provides. Also, a single payment method provided by payment method provider 334 may contain more than one incentive policy.

Incentive policy data 332 may also be received from incentive policy data source 338. Incentive policy data source 338 may be any source of data regarding incentives and rewards that are available for using a set of payment methods. For example, incentive policy data source 338 may be a web site, a proprietary database, or user input source. Incentive policy database 318 may maintain current data regarding incentives and rewards by periodically receiving updated incentive policy data 332 from incentive policy data source 338.

Payment method recommendation system 302 includes transaction parameter identifier 308. Transaction parameter identifier 308 identifies a set of parameters associated with a transaction. Transaction parameter identifier 308 identifies the set of parameters 340 based on transaction data 342. Non-limiting examples of parameters 340 that may be contained in the set of parameters include a category or type of business associated with the transaction, a location of the transaction, a category or type of item purchased by a user in a transaction, an identity of an item purchased by a user in a transaction manufacturer data, and an identity of the particular store or branch at which the transaction is located. The set of parameters includes at least one parameter associated with a transaction. A transaction may be any transaction for which a payment method can be utilized, such as a purchase transaction, a monetary exchange, or any other transaction in which currency is transferred.

Transaction data 342 is data related to a transaction. For example, transaction data 342 may be a location of the transaction, a type of business at which the transaction is taking place, items purchased during a transaction, a purchase price, manufacturer data, the identity of one or more parties involved in a transaction, information about one or more parties involved in a transaction, or any other data associated with the transaction.

Upon receiving transaction data 342, transaction parameter identifier 308 identifies a set of parameters 340 based on transaction data 342. For example, transaction parameter identifier 308 may identify a category or type of business based on transaction data 342 that contains a location of the transaction. As another example, transaction parameter identifier 308 may identify a category or type of purchased item based on transaction data 342 that contains the identity of the purchased item. Further examples of parameters 340 that may be contained in the set of parameters include a type of business associated with the transaction, a location of the transaction, an item purchased by a user in a transaction, manufacturer data, and an identity of the particular store or branch at which the transaction is located.

Additionally, transaction parameter identifier 308 may identify any portion of data in transaction data 342 as a parameter without modifying the data. For example, transaction parameter identifier 308 may identify a transaction location as a parameter based on transaction data that includes the transaction location.

Transaction parameter identifier 308 receives transaction data 342 from user 324, user interface 328, transaction site 344 or any combination thereof. In addition to the various embodiments of user interface 328 identified above, user interface 328 may be any device that allows a user to send transaction data 342 to transaction parameter identifier 308.

Transaction site 344 may be any site at which a transaction takes place. For example, transaction site 344 may be a physical location, such as a retail store, a shopping mall, or a service vendor. Also, transaction site 344 may be a web site or any other medium by which a consumer can electronically transfer currency or conduct a purchase transaction.

Transaction parameter identifier 308 may also receive location information 348 from global positioning system 350. In this alternative embodiment, the set of parameters 340 identified by transaction parameter identifier 308 includes a location of the transaction that is received from global positioning system 350.

User interface 328 and transaction site 344 may also be equipped to accept transaction data 342 as input from user 324. For example, user 324 may manually input transaction data 342 into user interface 328 or at transaction site 344. Alternatively, transaction data 342 may be inputted to user interface 328 or at transaction site 344 using various kinds of devices and technology, such as a scanner, radio-frequency identification (RFID) technology, Bluetooth technology, or any other medium by which transaction data 342 may be communicated. Transaction data 342 may also be communicated between user interface 328 and transaction site 344 using these same types of communication media.

User interface 328 may also be integrated with transaction site 344. For example, user interface 328 may be, without limitation, part of a checkout counter in a grocery store, a gas pump at a gas station, a phone booth, or an aAutomatic Teller Machine (ATM). As another example, user interface 328 may be part of a web site from which user 324 is conducting a transaction.

Payment method recommendation system 302 includes recommendation engine 306. Recommendation engine 306 generates a set of recommended payment methods in the set of payment methods using the user profile 322, the incentive policy data 332, and the set of parameters 340 to form a recommendation 314. The set of recommended payment methods are recommended to complete the transaction. Also, the set of recommended payment methods include at least one recommended payment method.

As an example, recommendation engine 306 may use user profile 322, the incentive policy data 332, and the set of parameters 340 to generate a set of recommended payment methods that maximizes the rewards earned by user 324 in a particular transaction. In this example, the set of recommended payment methods may be the payment methods owned or used by user 324 as indicated in user profile 322.

Recommendation 314 is sent to a recommendation output 346 of user interface 328, which provides recommendation 314 to user 324. Recommendation output 346 may be any interface capable of providing recommendation 314 to user 324, including the examples of user interface 328 already provided. Further, recommendation output 346 may be an output only device, such as a printer, speaker, or monitor.

Recommendation 314 may be generated in either a real-time mode or an off-line mode. In real-time mode, recommendation 314 is generated and provided to recommendation output 346 automatically based on the location of user 324. The location of user 324 may be determined using global positioning system 350 or through cell phone triangulation. In real-time mode, recommendation 314 may also be automatically generated and provided to recommendation output 346 in response to receiving transaction data 342 from user interface 328 or transaction site 344, irrespective of any input from user 324.

In off-line mode, recommendation 314 is generated and provided to recommendation output 346 in response to receiving manual input from user 324. For example, recommendation 314 may be generated and provided responsive to user 324 manually entering transaction data 342 into user interface 328 using a software application such as Microsoft® Money, Microsoft® Excel, or any application associated with payment method recommendation system 302. Off-line mode allows user 324 to receive payment method recommendations for planned or scheduled transactions.

Recommendation 314, which is generated by recommendation engine 306 and provided by recommendation output 346 of user interface 328, may include an identification of the incentives or rewards available for using each recommended payment method in recommendation 314. For example, recommendation output 346 may indicate whether the recommended payment methods reward cash-back, frequent flier miles, or points. Recommendation output 346 may also indicate the amount of the reward, such as cash-back, frequent flier miles, or points, which will be rewarded to user 324 in conjunction with a transaction. Also, recommendation output 346 may indicate any incentives offered by vendors, such as hotels, airlines, and retailers, based on the payment method used at the vendor.

Recommendation 314 may include a ranking of each payment method in the set of recommended payment methods, and rank each payment method in the set of recommended payment methods in accordance with the incentives or rewards available for using each payment method in the set of recommended payment methods. For example, and without limitation, each payment method in the set of recommended payment methods may be ranked such that the payment method that provides the highest monetary value of rewards according to incentive policy data 332 is ranked first. Alternatively, the set of recommended payment methods may be ranked according to criteria specified by user 324 in user profile 322, such as how frequently user 324 uses the payment method as indicated by user profile 322. As another example, the set of recommended payment methods may be generated such that rewards are maximized for a grouped user profile associated with group policy database 330.

An example of recommendation 314 that may be provided to recommendation output 346 is as follows:
1) Chase Perfect Card offers 1 percent cash-back.
2) Discover Card offers 1 percent if monthly spending is greater than $500, or 2 percent with condition of $2000 spending per month.
3) Washington Mutual debit card offers 1 percent but rebate is delivered once per year.

Alternatively, recommendation output 346 may include information related to incentive policies issued by vendors, such as hotels, airlines, and retailers. For example, recommendation output 346 may include the following recommendation 314:
1) Chase Perfect Card offers 1 percent cash-back.
2) American Express offers 1 percent but rebate is delivered once per year.
   a. Use your American Express card when staying at a Hilton Hotel as an Honors participant to receive a cash-back reward.

Payment method recommendation system 302 also includes verification engine 310. If the location or type of business at which a transaction takes place is not recognized by payment method provider 334, user 324 may not receive rewards for which user 324 would be otherwise entitled to receive. To ensure that payment method provider 334 possesses the information necessary to reward user 324 with a reward that is associated with a location, verification engine 310 sends location information 348 to payment method provider 334. Verification engine 310 receives location information 348 from global positioning system 350.

Verification engine 310 also receives transaction data 342 from user interface 328 and transaction site 344. Verification engine 310 provides transaction data 342 to payment method provider 334. Transaction data 342 passed by verification engine 310 may include a location or a type of business associated with the transaction. Providing transaction data 342 to payment method provider 334 ensures that payment method provider 334 credits user 324 with the correct amount of rewards.

Payment method recommendation system 302 includes payment method acquisition module 312. Payment method acquisition module 312 provides an application for user 324 to apply for the right to use a recommended payment method. The application is provided if a determination is made that a recommended payment method in a set of recommended payment methods is not available to the user 324. The application is provided on payment card acquisition interface 352.

Upon providing the application to user 324 on payment card acquisition interface 352, user 324 inputs payment card application information 354 into payment method acquisition module 312. Payment method acquisition module 312 then sends payment card application information 354 to payment method provider 334. Upon sending payment card application information 354 to payment method provider 334, user 324 may thereafter be able to use the payment method for which user 324 has applied. Hence, user 324 may receive rewards for a payment method user 324 was not associated with before the transaction.

In an alternative embodiment, the recommended payment method that is not available to user 324 includes a promotion offered by payment method provider 334. A promotion is any special allurement offered by payment method provider 334 to entice users to use the payment method offered by payment method provider 334. For example, a promotion may be an offer by payment method provider 334 to double the amount of cash rewards for using the payment method provider's payment method during a predetermined time period. In this embodiment, the right to use the recommended payment method includes the right to participate in a promotion associated with the recommended payment method. In yet another embodiment, the recommended payment method is itself a promotion offered by payment method provider 334. In these embodiments, user 324 may receive rewards using a promotion user 324 was not associated with before the transaction.

Payment method acquisition module 312 may also assign a rating to user 324 and provide the rating to payment method provider 334. The rating is an indicator that is based on any of a variety of user attributes, such as repayment ability and the frequency with which the user uses a particular payment. For example, the rating may be based on the credit report of user 324.

The rating may then be used by payment method provider 334 to determine whether to approve the application of user 324. In addition, the rating may be used to determine attributes of the payment method offered to user 324 in the event that the application of user 324 is approved. For example, payment method provider 334 may vary the credit limit or interest rate of a payment method based on the rating received from payment method acquisition module 312.

A rating may be any set of characters that is capable of communicating user attributes. For example, the rating may be a number or a letter in a scale such as 1-10 or A-Z. The rating may also be a credit score.

Payment method recommendation system 302 includes security module 313. Security module 313 allows the recommendation engine 306 to provide recommendation 314 to user 324 in response to receiving authentication data 356 from user interface 328. Examples of authentication data 356 include a pin code, a fingerprint, data from an identification device, or any other method that authenticates the identity of user 324.

Payment method recommendation system 302 also includes usage pattern module 399. Usage pattern module 399 identifies a set of patterns based on usage of the set of payment methods to form payment method usage patterns 398. For example, transaction data 342 from one or more users may be accumulated by usage pattern module 399, which then identifies a set of patterns based on the accumulate transaction data. Usage pattern module 399 provides the payment method usage patterns 398 to a payment method provider 334.

Payment method usage patterns 398 may be stored, aggregated and analyzed to determine market trends, fluctuation in the use of payment methods, and the effectiveness of particular types of incentive policies. Payment method usage patterns 398 may be provided to payment method providers, such as payment method provider 334, on a real-time or periodic basis. Payment method providers may then use these payment method usage patterns to update and create incentive programs, such as incentive program 336. Payment method usage patterns may also be used by payment method providers to create marketing campaigns and promotions.

The components of payment method recommendation system 302, namely central repository 304, recommendation engine 306, transaction parameter identifier 308, verification engine 310, payment method acquisition module 312, and security module 313, may all be contained on a single data processing system, such as any of data processing systems 104, 106, 110, 112, and 114 in FIG. 1 or data processing system 200 in FIG. 2. Alternatively, one or more components of payment method recommendation system 302 may each be included on a separate data processing system, such as data processing systems 104, 106, 110, 112, and 114 in FIG. 1. In this alternative embodiment, the components of payment method recommendation system 302 may communicate with one another via a network, such as network 102 of FIG. 1.

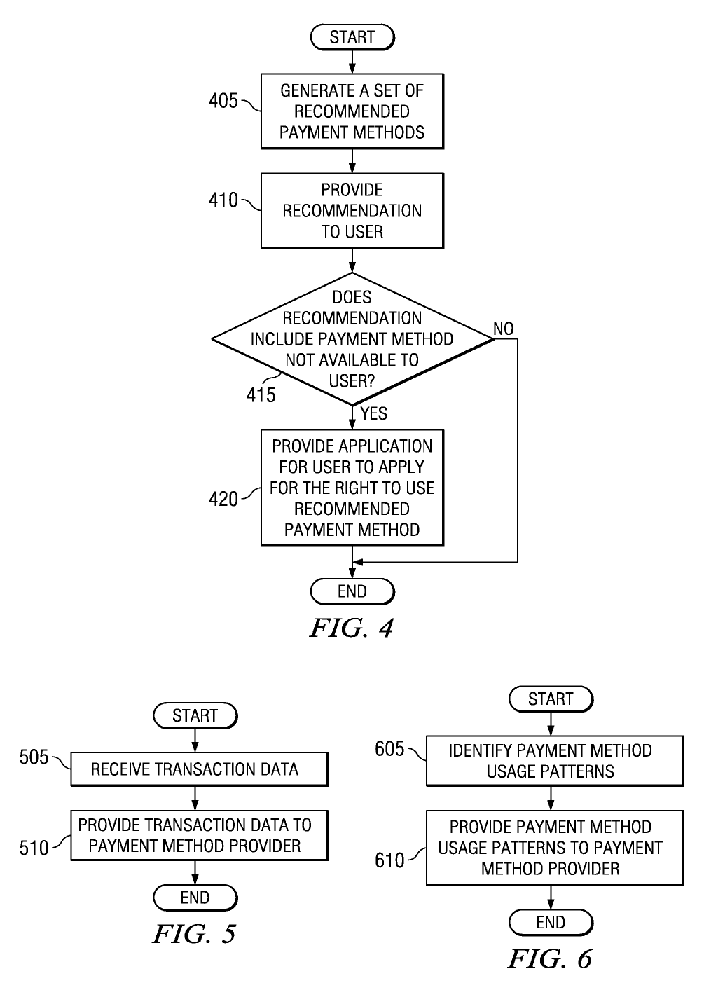

Turning now to FIG. 4, a flowchart illustrating a process for providing an application for a right to use a recommended payment method is depicted in accordance with an illustrative embodiment. The process illustrated in FIG. 4 may be implemented by a software component, such as payment method recommendation system 302 of FIG. 3.

The process begins by generating a set of recommended payment methods in a set of payment methods to form a recommendation (step 405). The set of recommended payment methods are recommended to complete the transaction. The process provides the recommendation to the user (step 410).

The process determines if the recommendation includes a payment method that is unavailable to the user (step 415). If the process determines that the recommendation does not include a payment method that is unavailable to the user, the process terminates.

If the process determines that the recommendation includes a payment method that is unavailable to the user, the process provides an application for the user to apply for the right to use the recommended payment method (step 420). The process then terminates.

Turning now to FIG. 5, a flowchart illustrating a process for verifying transaction data is depicted in accordance with an illustrative embodiment. The process illustrated in FIG. 5 may be implemented by a software component, such as verification engine 310 in FIG. 3.

The process begins by receiving transaction data (step 505). Alternatively, the process may begin by receiving location information from a global positioning system. The process provides the transaction data to a payment method provider (step 510). The process then terminates.

Turning now to FIG. 6, a flowchart illustrating a process for providing payment method usage patterns is depicted in accordance with an illustrative embodiment. The process illustrated in FIG. 6 may be implemented by a software component, such as usage pattern module 399 in FIG. 3.

The process begins by identifying a set of patterns based on usage of the set of payment methods to form payment method usage patterns (step 605). The process provides the payment method usage patterns to a payment method provider (step 610). The process then terminates.

The flowcharts and block diagrams in the different depicted embodiments illustrate the architecture, functionality, and operation of some possible implementations of the apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide a computer-implemented method, apparatus, and computer program product for providing user access to payment methods. In one embodiment, the process generates a set of recommended payment methods in a set of payment methods to form a recommendation. The set of recommended payment methods are recommended to complete the transaction. The process provides the recommendation to a user on a user interface. The process provides the application for the user to apply for the right to use the recommended payment method on a user interface in response to a determination that a recommended payment method in the recommendation is presently unavailable to the user. A set of payment methods includes one or more payment methods. A transaction may be any transaction for which a payment method can be utilized, such as a purchase transaction, a monetary exchange, or any other transaction in which currency is transferred.

In an embodiment, the process assigns a rating to the user and provides the rating to a payment method provider. The rating is an indicator that based on any of a variety of user attributes, such as repayment ability and the frequency with which the user uses a particular payment. In another example, the process receives data associated with the transaction to form transaction data and provides the transaction data to a payment method provider.

In another embodiment, the process identifies a set of patterns based on usage of the set of payment methods to form payment method usage patterns and providing the payment method usage patterns to a payment method provider. The set of patterns includes at least one pattern. A pattern characterizes data that is derived from usage of a set of payment methods by at least one user.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer-implemented method for providing user access to payment methods, comprising:
a processor generating a set of recommended payment methods in a set of payment methods to form a recommendation, wherein the set of recommended payment methods are recommended to complete a transaction;
the processor providing the recommendation to a user on a user interface;
determining whether the recommendation includes a recommended payment method that is presently unavailable to the user, wherein the recommended payment method includes an incentive for the user to use the recommended payment method; and
responsive to a determination that the recommendation includes a recommended payment method that is presently unavailable to the user, the processor providing an application on the user interface for the user to apply to a payment method provider for a right to use the recommended payment method, wherein the recommended payment method comprises one of a payment by a credit card and a payment by a debit card, and wherein providing an application on the user interface for the user to apply for the right to use the recommended payment method comprises providing an application on the user interface for the user to apply for the right to use one of the credit card and the debit card.

2. The computer-implemented method of claim 1, further comprising:
assigning a rating to the user; and
providing the rating to the payment method provider.

3. The computer-implemented method of claim 1, further comprising:
receiving location information from a global positioning system;
providing the location information to the payment method provider.

4. The computer-implemented method of claim 1, further comprising:
receiving data associated with the transaction to form transaction data; and
providing the transaction data to the payment method provider.

5. The computer-implemented method of claim 4, wherein the transaction data includes a location associated with the transaction.

6. The computer-implemented method of claim 4, wherein the transaction data includes a type of business associated with the transaction.

7. The computer-implemented method of claim 1, further comprising:
identifying a set of patterns based on usage of the set of payment methods to form payment method usage patterns; and
providing the payment method usage patterns to the payment method provider.

8. The computer-implemented method of claim 1, wherein the incentive comprises at least one of a cash-back reward, frequent flier miles, and points.

9. A computer program product, comprising:
a computer-readable medium having computer-usable program code for providing user access to payment methods, the computer program product comprising:
computer-usable program code for generating a set of recommended payment methods in a set of payment methods to form a recommendation, wherein the set of recommended payment methods are recommended to complete a transaction;
computer-usable program code for providing the recommendation to a user on a user interface; and
computer-usable program code, responsive to a determination that the recommendation includes a recommended payment method that is presently unavailable to the user, and which includes an incentive for the user to use the recommended payment method, for providing an application on the user interface for the user to apply to a payment method provider for a right to use the recommended payment method, wherein the recommended payment method comprises one of a payment by a credit card and a payment by a debit card, and wherein providing an application on the user interface for the user to apply for the right to use the recommended payment method comprises providing an application on the user interface for the user to apply for the right to use one of the credit card and the debit card.

10. The computer program product of claim 9, further comprising:
computer-usable program code for assigning a rating to the user; and
computer-usable program code for providing the rating to the payment method provider.

11. The computer program product of claim 9, wherein the incentive comprises at least one of a cash-back reward, frequent flier miles, and points.

12. The computer program product of claim 9, further comprising:
computer-usable program code for receiving data associated with the transaction to form transaction data; and
computer-usable program code for providing the transaction data to the payment method provider.

13. The computer program product of claim 12, wherein the transaction data includes a location associated with the transaction.

14. The computer program product of claim 12, wherein the transaction data includes a type of business associated with the transaction.

15. The computer program product of claim 9, further comprising:
computer-usable program code for identifying a set of patterns based on usage of the set of payment methods to form payment method usage patterns; and
computer-usable program code for providing the payment method usage patterns to the payment method provider.

16. A system for providing user access to payment methods, comprising:
a processor, the processor comprising:
a recommendation engine, wherein the recommendation engine generates a set of recommended payment methods in a set of payment methods to form a recommendation, wherein the set of recommended payment methods are recommended to complete a transaction, and wherein the recommendation engine provides the recommendation to a user on a user interface; and
a payment method acquisition module, wherein the payment method acquisition module, in response to a determination that the recommendation includes a recommended payment method that is presently unavailable to the user, and which includes an incentive for the user to use the recommended payment method, provides an application on the user interface for the user to apply to a payment method provider for a right to use the recommended payment method, wherein the recommended payment method comprises one of a payment by a credit card and a payment by a debit card, and wherein the application provided on the user interface comprises an application for the user to apply for the right to use one of the credit card and the debit card.

17. The system of claim 16, wherein the payment method acquisition module assigns a rating to the user and provides the rating to the payment method provider.

18. The system of claim 16, wherein the incentive comprises at least one of a cash-back reward, frequent flier miles, and points.

19. The system of claim 16, further comprising:
a verification engine, wherein the verification engine receives data associated with the transaction to form transaction data and provides the transaction data to the payment method provider.

20. The system of claim 16, further comprising:
a usage pattern module, wherein the usage pattern module identifies a set of patterns based on usage of the set of payment methods to form payment method usage patterns and provides the payment method usage patterns to the payment method provider.
